(19) United States
(12) Patent Application Publication
(10) Pub. No.: US 2010/0058807 A1
(43) Pub. Date: Mar. 11, 2010

(54) GLASS MELTING PLANT AND METHOD FOR OPERATING IT

(76) Inventors: Manfred Wagner, Lohr am Main (DE); Matthias Lindig, Ingelheim (DE)

Correspondence Address: GREER, BURNS & CRAIN, 300 S WACKER DR, 25TH FLOOR, CHICAGO, IL, 60606, US

(21) Appl. No.: 12/516,590

(22) PCT Filed: Jul. 25, 2008
(86) PCT No.: PCT/EP2008/006119

§ 371 Date: May 28, 2009

(30) Foreign Application Priority Data
Sep. 14, 2007 (DE) 102007044043.1

(51) Int. Cl. C03B 19/10; C03B 5/04

(52) U.S. Cl. 65/17.1; 65/181

(57) ABSTRACT

A glass melting installation and a method of operation of this with a melting tank, with burners for fossil fuels and with at least one regenerator for preheating oxidation gases, whereby between the at least one regenerator and the melting tank at least two step-free port necks are provided for the alternating supply of oxidation gases and the removal of combustion gases, and whereby the port necks are provided with lateral supply openings for the supply of secondary oxidation gases. In order to achieve injection into the waste gas flow without directional influence, with a simple construction and good energy usage, the supply openings for the supply of secondary oxidation gases are perpendicular to the free cross-section of the port necks above the step-free bottom surfaces.

### BACKGROUND OF THE INVENTION

The invention concerns a glass melting installation with a melting tank, with burners for fossil fuels and with at least one regenerator for preheating oxidation gases, whereby between the at least one regenerator and the melting tank at least two port necks are installed for the alternating supply of oxidation gases and the removal of combustion gases, whereby the port necks are provided with lateral openings for the supply of additional oxidation gases, and whereby the bottom surfaces of the port necks are constructed without any stepped changes to their cross-section.

### STATE-OF-THE ART

German patent DE 198 18 953 C 1 refers to a glass melting furnace with regenerators and alternating reversal of the operation of pairs of port necks, in which the NOₓ and CO content in the waste gases can be reduced by using fans to blow in sufficient air to produce more or less stoichiometric after-burning in the base of the regenerators, i.e. below the regenerator checkerwork. However, with this process it is necessary to provide the excess fuel required for the after-burning, as the temperatures in the regenerator base will be relatively low as a result of the heat previously transferred to the regenerator checkerwork. It is also stated correctly that the after-burning raises the temperature to at least 400° C. and that the energy is recovered by passing the waste gases through a raw material preheater. It is also stated that the conditions for the reduction of both NOₓ and CO are diametrically opposed.

Similar considerations are also contained in German patent DE 19543743 A1,in which air for after-burning is similarly introduced below the regenerator checkerwork. In this case a matrix of downward pointing nozzles creates a barrier against the rising air, and this necessitates significant modifications to the design of the regenerators.

From German patent DE 101 18 880 C2 and the corresponding European patent EP 1 252 105 B1 it is known that, in order to prevent soot and graphite deposits without increasing the NOₓ content of the waste gases of glass melting furnaces, it is possible to install secondary burners in the form of combination nozzles in the side walls of alternately operating pairs of port necks and to use these nozzles for the supply of secondary fuel gas and oxidizing agents during the heating phase of the corresponding port neck, below which primary burners are installed in the normal underport arrangement. In order to increase the lateral effect of the secondary burners or secondary flames these port necks have steps in which the secondary flames burn. It is also stated that oxidizing agents, albeit without fuel gas, continue to be introduced into these port necks during the exhaust phase of the combustion gases from the melting chamber. However, in practice it has been shown that the steps are a hindrance to the after-burning of any excess fuel present in the waste gases, because the oxidizing agents do not mix sufficiently with the waste gases, but flow back into the melting chamber, where they are no longer able to effect a reduction of the content of dangerous CO in the waste gases.

From German patent DE 43 01 664 A1 a glass melting furnace with regenerators and alternating reversal of the operation of pairs of port necks is known in which it is possible to shorten the flame path despite stepped combustion by taking hot air from the upper part of a regenerator during its heating phase, passing it over the melting tank and introducing it above the opposite burner port in counterflow to the waste gas flow. On the one hand sub-stoichiometric combustion that takes place in the first stage becomes stoichiometric in the second stage, while on the other hand this arrangement produces, as intended, a strong turbulence above the glass melt in the combustion chamber, and this has a negative influence on the primary flame and the heat distribution.

Through U.S. Pat. No. 5,795,364 it is known that in the case of a glass melting furnace with regenerators and alternating reversal of the operation of pairs of port necks, primary fuel is introduced into the burner ports during the combustion phase, while secondary fuel, described as “reburn fuel,” is introduced during the exhaust phase. This secondary fuel produces intensive after-burning, while air is blown into the upper checkerwork of the regenerators in counterflow to the waste gas flow in order to create turbulence and ensure that the ensuing gases are fuel-deficient. This procedure leads to fuel wastage, because energy recovery from the regenerators involves losses.

From German patent DE 100 44 237 A 1 and the corresponding document No. WO 02/02468 A 1 it is further known, that in order to reduce the NOₓ content in the waste gases of glass melting furnaces it is possible to install burners and, where necessary, inlets for waste gases in both side walls of port necks, also known as combustion air ports, and in addition to install so-called flame root shields perpendicular to the combustion air flow, whereby these shields leave a gap through which the air stream can enter laterally, producing cross-flows that reduce the turbulence and flow underneath the waste gas stream. The flame root shields create areas sheltered from the flow, and can have various shapes such as wedge, pitch-roof or rectangular either in the direction of the air flow or perpendicular to it. In any case two sharp-edged steps are created in the outward flow direction. As a result, it is necessary to carry out extensive and expensive modifications to the walls and bottom of the port necks made of ceramic materials, as indicated by the description of the necessity to cut material out of the bottom. This type of arrangement is hardly suited to the retrofitting of existing port necks. The return flow of waste gases from the combustion chamber over the melting tank during alternating operation is not described, nor is secondary oxidation, and nor is any information about the influence on the CO content of the waste gases given.

From U.S. Pat. No. 6,047,565 it is known that the bottom surfaces of port necks in glass melting furnaces can be built with or without steps. If nozzles are provided in the side walls of the port necks they are used for the injection of small quantities of fuel, amounting to between about 5 to 30% of the total quantity. It is not disclosed that an oxidant should be introduced through these nozzles even during the return flow of the combustion gases, and if this should happen, it would cause a pressure build-up as a result of the acute-angled alignment of the nozzles towards the furnace interior, and this would hinder the exhaust flow from the furnace interior and change the stoichiometry therein.

From U.S. Pat. No. 5,755,846 it is known that nozzles for the introduction of additional fuel can be installed in the roof, the bottom and a side wall of port necks, in order to produce layered combustion of sub and over-stoichiometric gas mixtures. Nothing is disclosed about the injection of secondary oxidants.

From European patent EP 1 634 856 A 1 it is known that floating nozzles can be installed in opposite port necks with their openings directed into the furnace chamber. Oxidants can be injected into the furnace combustion chamber through these nozzles, even during the waste gas exhaust phase. However, these nozzles also create a barrier for the waste gases and this restricts their flow, while the after-burning is limited to the furnace interior.

From U.S. Pat. No. 5,417,731 it is known that it is possible to introduce secondary oxidants into the port necks during the exhaust phase in order to achieve after-burning of carbon monoxide. However, once again the acute-angled alignment of the nozzles in the direction of the furnace interior causes a pressure build-up, which hinders the waste gas exhaust flow from the furnace interior.

A summary of the state-of-the-art also shows that the following problems still exist: The optimization of the combustion gas-air-ratio towards near-stoichiometric combustion is state-of-the-art for glass melting furnaces heated with fossil fuels. The near-stoichiometric combustion guarantees an optimum flame temperature and energy usage. Stoichiometric combustion is the term used when exactly the combustion air quantity is used so that its oxygen content is that required to convert the hydrocarbon molecules in the fuel completely into the reaction products water and carbon dioxide. This exothermic process takes place above the fuel ignition temperature, i.e. it gives off heat. It should be also be noted here that both reaction products are also responsible for the heat transfer.

Both sub or over-stoichiometric combustion processes deviate from the optimum point of energy usage. The near-stoichiometric combustion is also a primary measure for reducing the emission of NOₓ. Normally the fuel-air-ratio is measured as the excess oxygen content of the waste gases. The excess oxygen is usually approximately 0.5%, based on dry waste gases under standard reference conditions.

The increasing viscosity of the gases at high temperatures impedes good mixing of the preheated combustion air and fuel. The preheated air which is supplied to the combustion has a temperature of approximately 1250° C., and its viscosity is therefore 0.5*10⁻³kg/ms. This is of the same magnitude as liquids. The expert refers to this as “streak formation,” when he appraises the measurable, uneven distribution of the combustion products in the waste gas flow. In the case of near-stoichiometric combustion in particular there is an increased risk that carbon monoxide will also be found in the waste gases, despite the fact that there is also a small level of oxygen in the waste gases.

This problem was probably the reason for choosing to mix the fuel as well as possible with the combustion air early on in the process, in order to ensure complete burnout. However, practice showed that the formation of nitrogen oxides increases when the fuel is swirled. Swirling therefore has a contrary and very negative effect. It has been shown that a stable flame is necessary for combustion with low pollutant emissions.

According to the state-of-the-art, until now additional fuel and oxidants have been mainly added before the combustion chamber on the fresh-air side of regenerative combustion installations. This is known as “cascade” heating. It is known that the aim of such a process in which secondary fuel is added, is to create a flame front that lies over the actual primary or main flame, prior to the actual combustion. However, this delays combustion of the main fuel stream and produces a sub-stoichiometric mixture around the flame root and reduces the temperatures around the flame core. However, both effects lead only to a reduction in NOₓ formation.

Further development showed that it was advantageous if the secondary fuel was injected behind a step in the port neck (e.g. German patent DE 101 18 880 C2).

This ensured that the secondary fuel was distributed across the complete width of the port neck and air supply. However, the step also led to an increase in soot formation with undesirable soot deposits near the additional fuel input. Attempts were made to solve this problem by adding a small amount of secondary air to the secondary fuel. This secondary air also served as an oxidant, although this was mainly on the firing side. The addition of secondary fuel was interrupted on the exhaust side, but the supply of oxidants was maintained in order to remove the soot deposits In this case, however, the step is counter-productive as it hinders the mixing of the oxidant with the exhaust gases. Therefore this measure did not prove advantageous for producing an effective reduction of the CO content in the waste gases: The step prevents the oxidant from mixing with the waste gases which would allow after-burning.

### SUMMARY OF THE INVENTION

The object of the invention is therefore to describe ways and means for the aforementioned glass melting installation, with which it is possible to retrofit and convert existing port necks very simply and effectively, and with which it is possible to attain an optimal flame temperature with good energy usage, and whereby the incompletely burnt and/or oxidized components of the fuel are oxidized, and whereby the CO content of the waste gases in particular is reduced, without causing an increase in the NOₓ content. In particular, the aim is to avoid or limit constructional measures that make it necessary to enter the port necks.

### Achievement by Means of the Inventive Apparatus:

The object of the invention is achieved by the aforementioned glass melting furnace in such a way, that

the openings for the supply of additional oxidation gases are aligned with the free cross-section of the port necks above the bottom surfaces,

the openings for the oxidation gases are connected by pipes to fans for the oxidation gases, and that

the supply openings for the oxidation gases enter the port necks at right angles.

The combination of characteristics b) and c) is particularly important. Independent of whether oxidation gas is blown in during the firing phase or the waste gas exhaust phase of the relevant burner, as it has a neutral effect on a possible directional flow component of the oxidation gas: In the direction towards the furnace interior, in particular, no pressure build-up occurs that could hinder the removal of combustion gases, a state which could lead to a change in the stoichiometry in the furnace chamber. Up until now this information has not been mentioned in any description of the state-of-the-art. On the contrary, in U.S. Pat. No. 5,417,731 the opposite is actually recommended, namely that the secondary oxidation gas should be introduced into the furnace in the opposite direction to the gases from the combustion reaction that flow through the waste gas channel.

The object of the invention is accomplished completely in that it is possible to carry out simple and effective conversion and retro-fitting of existing port necks, and also in that it is possible to achieve the optimum flame temperature with good energy usage, whereby the incompletely burnt and/or oxidized fuel components are oxidized and that, in particular, the CO content of the waste gases is reduced to almost zero, without producing an increase in the NOₓ content. In particular, any constructional measures that make it necessary to enter the port necks are avoided or limited.

The invention especially assists primary combustion under near-stoichiometric conditions, i.e. combustion in the furnace where only a small amount of unburned or partially burnt primary fuel remains, which can then be converted, at least for the most part, into waste gases with a barely measurable CO content. This also solves the problem resulting from the insufficient mixing of gases that is caused by the fact that at the normal temperature of about 1250° C. the preheated combustion air for the primary combustion has a viscosity of 0.5*10⁻³ kg/ms, which leads to streaks or cords in the gas mixture.

In particular, this makes it possible to comply with legal regulations concerning the CO content of waste gases without recourse to additional measures: The CO formed in the combustion chamber of the furnace is oxidized shortly after leaving the combustion chamber. In practice the level of carbon monoxide was in the region of 100 mg/Nm³, and peak values of 1000 mg/Nm³ are also known. The invention has made it possible to reduce the level of carbon monoxide to almost zero.

As a result of further embodiments of the aforementioned glass melting installation it is particularly advantageous if, either singly or in combination:

the supply openings for the oxidation gases are installed in an area near to the center of the vertical distance between the bottom and roof surfaces of the port necks,

the supply openings for the oxidation gases are installed in an area near to the center of the distance between the two ends of the port necks,

the cross-sections of the supply openings for the oxidation gases are between 20 and 350 cm², preferably between 50 and 80 cm²,

the supply openings for the oxidation gases are surrounded by cylindrical wall surfaces,

the supply openings for the oxidation gases have a diameter between 50 and 200 mm, preferably between 80 and 100 mm, and/or, if

the supply openings for the oxidation gases are between 100 and 500 mm long, preferably between 300 and 400 mm.

### Achievements by Means of the Inventive Process:

The invention also concerns a method of operating glass melting installations with a melting tank, with fossil fuel burners and with at least one regenerator for preheating the oxidation gases, whereby, between the at least one regenerator and the melting tank at least two port necks for the alternating supply of oxidation gases and the removal of combustion gases are installed, whereby the port necks are provided with lateral openings for the supply of additional oxidation gases, and whereby the currents inside the port necks are not interrupted by any steps.

In order to accomplish the aforementioned tasks and to achieve the same advantages such a process is characterized by the fact that

the supply of supplementary oxidation gases is directed into the free cross-section above the bottom surfaces of the port necks during the exhaust phase of the combustion gases,

the supplementary oxidation gases are blown into the port necks by a fan, and that

the oxidation gases are blown into the port necks at right-angles to the flow.

As a result of further embodiments of the aforementioned method it is particularly advantageous, if—either singly or in combination—:

the additional oxidation gases are introduced into the port necks in an area near the center of the vertical distance between their bottom and roof surfaces,

the additional oxidation gases are introduced into the port necks in an area near the center of the distance between the two ends of the port necks,

the additional oxidation gases are introduced into the port necks through cylindrical wall areas in the burner blocks,

the additional oxidation gases are supplied at flow velocities between 5 and 20 m/s, preferably between 8 and 10 m/s, and/or, if

the proportion of the additional oxidation gases is between 1 and 7%, preferably between 4 and 6%, of the amount required for the primary combustion.

### BRIEF DESCRIPTION OF THE DRAWINGS

An example of the object of the invention and its operation and further advantages are explained in more detail below, referring to FIGS. 1 to 5. The figures show:

FIG. 1 an horizontal section through a regenerator with two chambers, through two port necks and the charging area of a melting tank,

FIG. 2 a vertical section through one of the port necks,

FIG. 3 an enlarged horizontal section through one of the port necks shown in FIG. 1,

FIG. 4 a 3-dimensional view of a burner block with an opening for the supply of oxidation gases to the port necks, and

FIG. 5 a vertical section through a wall section of a port neck with integrated burner block.

### DETAILED DESCRIPTION OF THE PREFERRED EMBODIMENTS

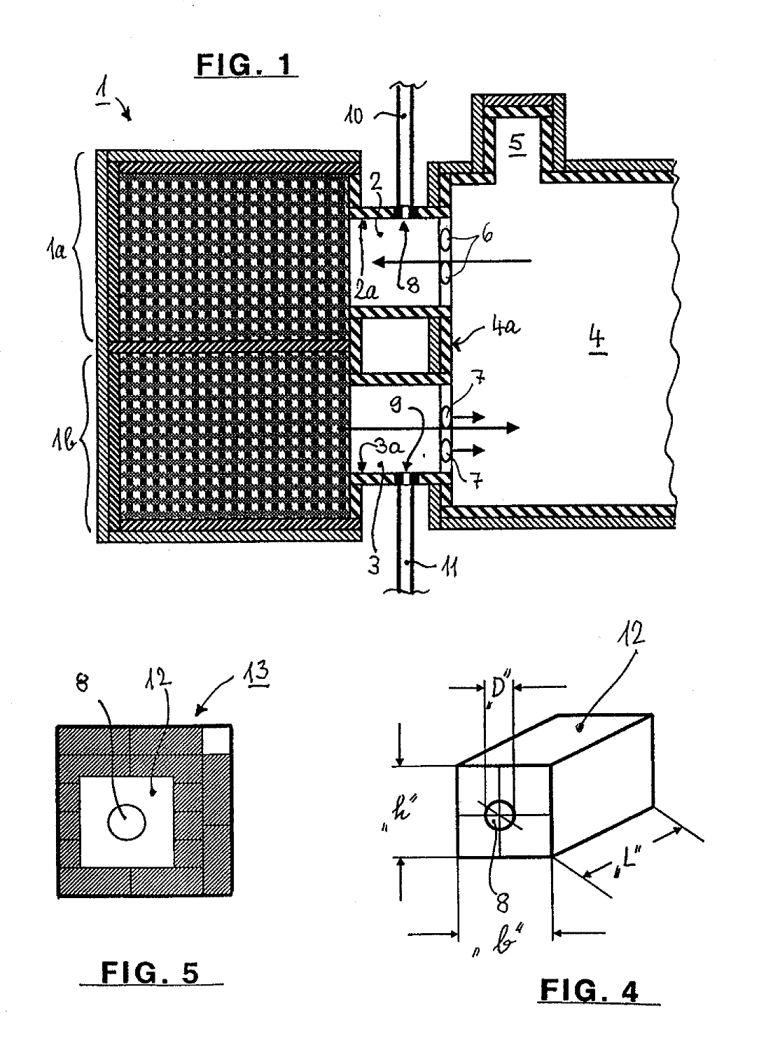

FIG. 1 shows a regenerator 1 with two regenerator chambers 1a and 1b of a known type, each connected individually to the charging end of a melting tank 4 by means of port necks 2 and 3. The charging material, also referred to as batch, is introduced through a so-called doghouse 5, that may have a counterpart on the opposite side of the melting tank 4. Burners 6 and 7 for fossil fuels are installed below the port necks 2 and 3 and just above the contents of the melting tank 4, whereby only the openings of burners 6 and 7 are indicated. The firing method is described as underport firing and is also known.

As shown in FIG. 1, the heating process is taking place in the lower port neck 3, and preheated oxidation gas, normally air, from the regenerator chamber 1b is added to the combustion gases in the direction of the long arrow. Simultaneously, when the combustion gas has transferred a large proportion of its heat to the melting tank 4 it flows through the other port neck 2 (in the upper part of the figure), whereby the related burners 6 are not in operation. This operation is reversed approximately every 20 minutes. This construction and operation method is state-of-the-art technology, for example as stated in German patent DE 198 18 953 C 1 from the same applicant.

At this point the invention becomes relevant: Supply openings 8 and 9 are provided in the external side walls 2a or 3a of each of the port necks 2 and 3 for the supply of additional oxidation gases perpendicularly into the free cross-section of the port necks 2 and 3. Each of these supply openings is connected to a pipe 10 or 11.

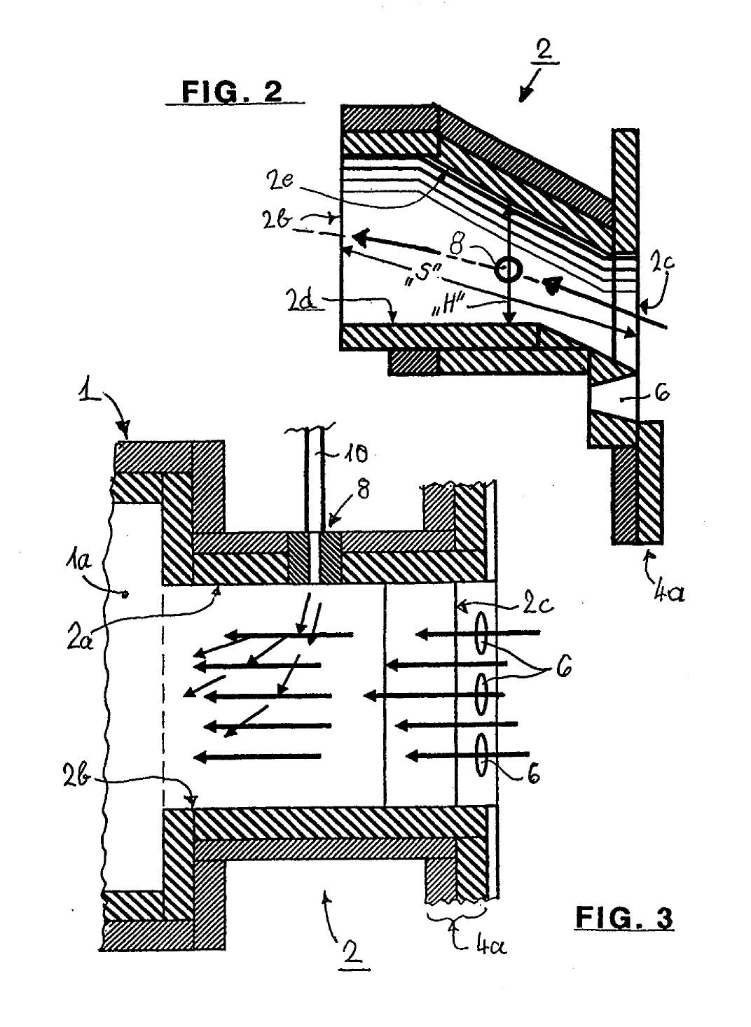

The reference numbers used so far are used again in FIG. 2 which shows the following: The port neck has a left-hand end 2b, connected to the regenerator chamber 1a, and a right-hand end 2c, that lies above the edge 4a of melting tank 4. It can be seen clearly that although the port neck 2 has a slightly angled bottom surface 2d, there are no stepped changes in the cross-section, and the supply opening 8 is installed above the bottom surface 2d in such a way that the additional oxidation gas from supply opening 8 is directed at the free cross-section of the port neck 2 above this bottom surface 2d. It can also be seen that the supply opening 8 is located in an area near the center of the vertical distance “H” between the bottom surface 2d and the arched roof surface 2e. Furthermore, the supply opening 8 is also located in an area in the center of the flow path “S” between the two ends 2b and 2c.

FIG. 3, from which the regenerator packing in regenerator chamber 1a has been omitted, shows the following in combination with FIG. 2: Bold arrows symbolizing the flow direction of the combustion gases from the tank in the direction of regenerator chamber 1a, i.e. during the exhaust phase. Hereby the additional oxidation gas normally ambient air blown by fans into the pipe 10—is blown in through supply opening 8 with such impetus that it initially moves perpendicularly and therefore without directional influence in the direction shown by the thin arrows and then mixes with the combustion gases and oxidizes the remaining carbon monoxide. This oxidation process can continue into the regenerator chamber 1a.

FIGS. 4 and 5 show a particularly advantageous design for the supply openings 8 and 9: A supply opening 8 in the form of a continuous channel, that is surrounded by a cylindrical wall with a diameter “D,” is installed in a rectangular burner block 12 made from a heat-resistant mineral material. The diameter “D” can be between 50 and 200 mm, preferably between 80 and 100 mm . The length “L” can lie between 300 and 400 mm. If the diameter “D” is 80 mm, it is advantageous to choose a height “h” of 200 mm and a width “b” also of 200 mm. If the installation is made according to FIG. 5 in a block 13, which is 380 mm high and wide, made from blocks of a heat-resistant mineral material, a wall insert is produced that can be installed or retrofitted—easily and cheaply—in an existing glass melting installation.

As a result of flow velocities between 5 and 20 m/s, preferably between 8 and 10 m/s at the outlet of the supply opening 8, the oxidation gas can penetrate the flow of combustion gases and ensure that the gases are well mixed and burnt. It is useful if the proportion of the additional oxidation gases is between 1 and 7% of the oxidation gases required for the primary combustion over the glass melt, and this can be achieved if the fans, which are not shown here, attached to pipes 10 and 11 are sized correctly. Of course this also applies to port neck 3 with the corresponding time offset.

FIG. 1 shows the conditions in a so-called U-flame furnace, in which the flow of the combustion gases above the glass melt is turned through 180°. The same advantages also apply when the invention is used with so-called cross-fired furnaces, in which pairs of port necks that operate together are installed in opposite side walls of the furnace.

From the above description, it is apparent that the objects of the present invention have been achieved. While only certain embodiments have been set forth, alternative embodiments and various modifications will be apparent from the above description to those skilled in the art. These and other alternatives are considered equivalents and within the spirit of scope of the present invention. It should be understood that we wish to embody within the scope of the patent warranted heron all such modifications as reasonably and properly come within the scope of my contribution to the art.

1-18. (canceled)

19. A glass melting installation comprising:
a melting tank with burners for fossil fuels and with at least one regenerator for preheating oxidation gases,
at least two port necks being installed between the at least one regenerator and the melting tank for an alternating supply of oxidation gases and removal of combustion gases,
lateral supply openings being provided in the port necks to provide a supply of additional oxidation gases,
bottom surfaces of the port necks being formed with no step-shaped changes to a cross-section of the port necks,
the lateral supply openings being aligned with a free cross-section of the port necks above the bottom surfaces,
the lateral supply openings being connected by pipes to fans for the oxidation gases, and
the lateral supply openings opening into the port necks at right angles.

20. The glass melting installation according to claim 19, wherein the lateral supply openings are installed in an area near a center of a vertical distance between the bottom surfaces and roof surfaces of the port necks.

21. The glass melting installation according to claim 19, wherein the lateral supply openings are installed in an area near a center of a flow path between two ends of the port necks.

22. The glass melting installation according to claim 19, wherein the lateral supply openings have cross-sectional areas of between 20 and 350 cm².

23. The glass melting installation according to claim 22, wherein the lateral supply openings have cross-sectional areas of between 50 and 80 cm².

24. The glass melting installation according to claim 19, wherein the lateral supply openings are surrounded by cylindrical wall surfaces.

25. The glass melting installation according to claim 24, wherein the lateral supply openings have a diameter of between 50 and 200 mm.

26. The glass melting installation according to claim 25, wherein the lateral supply openings diameter is between 80 and 100 mm.

27. The glass melting installation according to claim 19, wherein the lateral supply openings have lengths between 100 and 500 mm.

28. The glass melting installation according to claim 19, wherein the lateral supply openings have lengths between 300 and 400 mm.

29. A method for the operation of glass melting installations with a melting tank, with burners for fossil fuels and with at least one regenerator for preheating oxidation gases, whereby the at least one regenerator and the melting tank are connected by at least two port necks for the alternating supply of oxidation gases and the removal of combustion gases, whereby the port necks are provided with lateral supply openings for the supply of additional oxidation gases, and whereby the flows inside the port necks are not interrupted by steps, comprising the steps:
aligning the supply of additional oxidation gases in the exhaust phase of the combustion gases with the free cross-section of the port necks above the bottom surfaces,
using a fan to introduce the additional oxidation gases into the port necks, and
blowing the oxidation gases into the port necks at right angles to a flow of oxidation gases and combustion gases.

30. The method according to claim 29, including the step of introducing the additional oxidation gases in an area near a center of a vertical distance between the bottom surfaces and roof surfaces of the port necks.

31. The method according to claim 29, including the step of supplying the additional oxidation gases to the port necks in an area near a center of the flow path between two ends of the port necks.

32. The method according to claim 29, including the step of injecting the additional oxidation gases into the port necks through cylindrical wall surfaces in burner blocks.

33. The method according to claim 29, including the step of adding the additional oxidation gases with flow velocities between 5 and 20 m/s.

34. The method according to claim 33, wherein the additional oxidation gases are added with flow velocities between 8 and 10 m/s.

35. The method according to claim 29, wherein the amount of additional oxidation gases is provided in a range of between 1 and 7% of an amount of oxidation gas needed for the primary combustion.

36. The method according to claim 35, wherein the amount of additional oxidation gases is provided in a range of between 4 and 6% of the amount of oxidation gas needed for the primary combustion.
